(19) United States
(12) Patent Application Publication
(10) Pub. No.: US 2019/0332469 A1
(43) Pub. Date: Oct. 31, 2019

(54) ADDRESS RANGE BASED IN-BAND MEMORY ERROR-CORRECTING CODE PROTECTION MODULE WITH SYNDROME BUFFER

(71) Applicant: INTEL CORPORATION, Santa Clara, CA (US)

(72) Inventors: Amir A. RADJAI, Portland, OR (US); Nagi ABOULENEIN, King City, OR (US); Steve L. GEIGER, Hillsboro, OR (US); Satyajit A. JADHAV, Hillsboro, OR (US); Bezan J. KAPADIA, Portland, OR (US); Vivek KOZHIKKOTTU, Hillsboro, OR (US); Rashmi LAKKUR SUBRAMANYAM, Hillsboro, OR (US); Srithar RAMESH, Portland, OR (US); James M. SHEHADI, Portland, OR (US); Jason D. VAN DYKEN, Portland, OR (US)

(21) Appl. No.: 16/504,199

(22) Filed: Jul. 5, 2019

(51) Int. Cl. G06F 11/10; G06F 13/16; G06F 9/38; G06F 9/54

(52) U.S. Cl. CPC G06F 11/1044; G06F 9/544; G06F 9/3816; G06F 13/1668

(57) ABSTRACT

An in-band error correcting code (ECC) module intercepts input/output (I/O) operations directed to a memory. The in-band ECC module determines whether the I/O is directed to data that needs to be protected against error. In response to determining that the I/O is directed to data that needs to be protected against error, the in-band ECC module directs a memory controller to store or access ECC data corresponding to the data in a first preassigned area of the memory, and to store or access the data in a second preassigned area of the memory.

### BACKGROUND

Error-correcting code (ECC) memory is a type of computer data storage that detects and corrects many types of internal data corruption. Typically an ECC memory maintains a memory system immune to one or multiple bits of errors. In ECC memory the data that is read from each word is the same as the data that had been written to it, even if one or more of the bits actually stored in the ECC memory has been flipped to the wrong state. Syndrome tables are a mathematical way of identifying bit errors and then correcting the bit errors, and syndrome spaces may be used in such syndrome based decoding.

ECC memory is used to provide reliability for applications that cannot tolerate data corruption. ECC memory may be comprised of an extra device on a dual in-line memory module (DIMM) which provides the additional ECC storage, as well as data lane so that ECC information is written and read along with the data. For example on a DDR4 with x8 devices, an ECC DIMM may be comprised of 9 such devices to form a 72 bit channel, where 64 bits are used to transfer the data and 8 bits are used for ECC data transfer. Data may be protected with Single Error Correction and Double Error Detection (SECDED) with 8 bits for every 64 bits of data transfer. ECC DIMMS are typically more expensive than regular DIMMs.

### BRIEF DESCRIPTION OF THE DRAWINGS

Referring now to the drawings in which like reference numbers represent corresponding parts throughout:

FIG. 1 illustrates a block diagram that shows the placement of an in-band ECC module in a memory subsystem, in accordance with certain embodiments;

FIG. 2 illustrates a block diagram that shows how the memory space is divided into a system visible memory and an ECC syndrome space, in accordance with certain embodiments;

FIG. 3 illustrates a flowchart that shows certain operations performed by the in-band ECC module, in accordance with certain embodiments;

FIG. 4 illustrates a block diagram that shows an in-band ECC module with a recent syndrome buffer, in accordance with certain embodiments;

FIG. 5 illustrates a block diagram that shows elements in the in-band ECC module and operations performed within the in-band ECC module, in accordance with certain embodiments;

FIG. 6 illustrates a flowchart that shows certain additional operations performed by the in-band ECC module, in accordance with certain embodiments; and

FIG. 7 illustrates a block diagram of a system, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

ECC memory increases cost due to additional DRAM devices and the data lane. For high-end systems, customers have traditionally invested in the extra costs needed to populate special ECC DRAMs compared to regular DRAMs. However, for low-end systems in the internet of things (IoT) domain, cost is a very important parameter. For example, when using Low Power DDR (LPDDR) memory with 16 bit channel width, the cost of adding dedicated devices per channel for ECC protection is prohibitive. Therefore, in order to support low cost and the ECC requirement, in-band ECC mechanisms may be used.

In-band ECC allows for single error correction and double error detection with much lower capacity overhead and with no pin count increase. Data is protected at a configurable granularity (64 Bytes, 32 Bytes, 16 Bytes, etc.) with 2-bytes of ECC value. A portion of the total DRAM size is reserved to store these ECC data.

Enabling in-band ECC causes performance penalty, as each read or write access to memory is translated into an additional request to read or write the ECC data and thus increasing the memory bandwidth. Certain embodiments provide mechanisms to reduce this performance penalty by allowing configurable protected address ranges and by implementing a recent syndrome buffer. In certain embodiments, other mechanisms may be used to reduce the performance penalty.

In certain embodiments, the in-band ECC is implemented in a separate module that is placed before the memory controller in a system on chip (SoC). Having in-band ECC functionality in an independent module allows for portability and reuse across different SoCs without changes to existing modules. It also allows for power gating of the whole in-band ECC module when ECC protection is not needed.

The in-band ECC module improves safety and reliability by providing error check and correction to all or specific regions of the physical memory space. The in-band ECC module can be enabled for memory technologies that do not support the out-of-band ECC, where the cost of adding an additional device to each channel for ECC data storage is prohibitive.

In certain embodiments, the in-band ECC module is placed on the path of memory reads and writes to a DRAM memory controller (or any other type of addressable memory element). The in-band ECC module recognizes whether a region should be ECC protected based on the incoming request address. As reading and generation of ECC data adds additional bandwidth overhead, a recent syndrome buffer inside the in-band ECC module may be used to reduce this overhead, by storing the recently used ECC data.

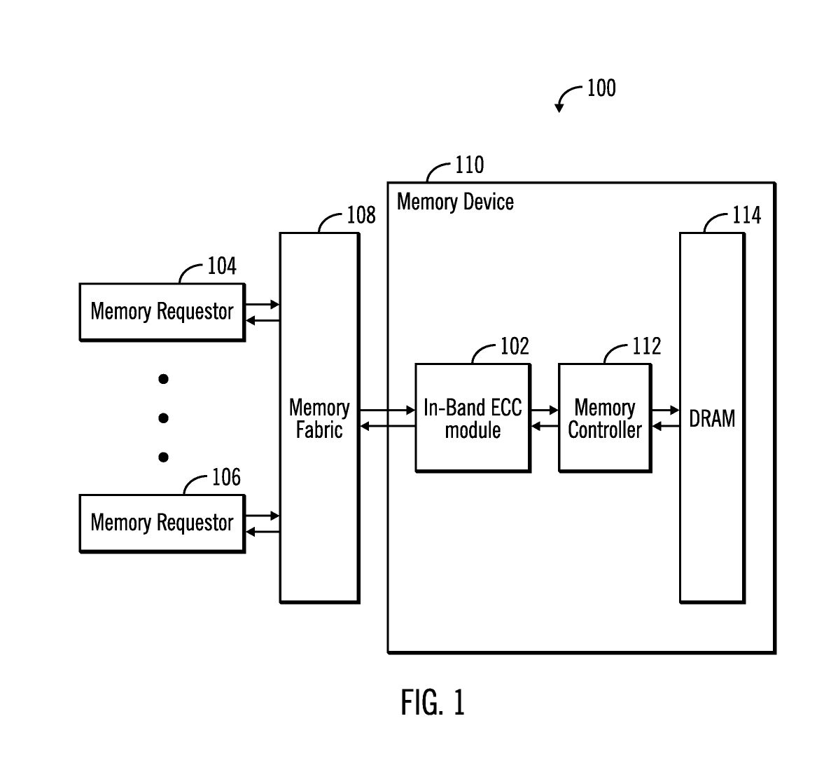

FIG. 1 illustrates a block diagram 100 that shows the placement of an in-band ECC module 102 in a memory subsystem, in accordance with certain embodiments.

A plurality of memory requestors 104, 106 may transmit input/output (I/O) requests comprising reads and writes via a memory fabric 108 to a memory device 110. The plurality of memory requestors 104, 106 may comprise host computational systems or other devices.

The in-band ECC module 102 is placed in the memory device 110 in a configuration such that the I/O requests are intercepted and processed by the in-band ECC module 102 before further processing by a memory controller 112 for accessing the DRAM 114 (other memory besides the DRAM 114 may be used in alterative embodiments). While in FIG. 1 the in-band ECC module 102 has been shown as a separate module from the memory controller 112, in certain embodiments, the in-band ECC module 102 or its operations may be implemented in the memory controller 112.

In FIG. 1, the in-band ECC module 102 sits on the path of memory reads and writes to the memory controller 112, and protects data at a configurable granularity (64 B, 32 B, 16 B, etc.), with a 16-bit single error correction and double error detection code. The in-band ECC module 102 sits on the way to the DRAM memory 114 and when enabled, intercepts all requests to the memory controller 112.

Although the in-band ECC module 102 supports ECC protection of all of the memory address space in the DRAM 114, it is expected that only a smaller portion of memory address space needs to be ECC protected, and only critical applications are allocated into that protected space. This reduces the bandwidth overhead of enabling in-band ECC as accesses to unprotected regions do not generate additional requests to read or write the ECC data.

Although various embodiments are described with respect to a dynamic volatile memory such as the DRAM 114, embodiments can be applied to any memory devices or devices that propagate values. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5), LPDDR5 (LPDDR version 5), HBM2 (HBM version 2), and/or others, and technologies based on derivatives or extensions of such specifications.

In addition to, or alternatively to, volatile memory, in certain embodiments, reference to memory devices can refer to a nonvolatile memory device whose state is determinate even if power is interrupted to the device. In one embodiment, the nonvolatile memory device is a block addressable memory device, such as NAND or NOR technologies. Thus, a memory device can also include a future generation nonvolatile devices, such as a three dimensional crosspoint memory device, or other byte addressable nonvolatile memory devices. In one embodiment, the memory device can be or include memory devices that use chalcogenide phase change material (e.g., chalcogenide glass), multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, a spintronic magnetic junction memory based device, or a combination of any of the above, or other memory.

Descriptions herein referring to a “DRAM” can apply to any memory device that allows random access, whether volatile or nonvolatile. The memory device or DRAM can refer to the die itself and/or to a packaged memory product.

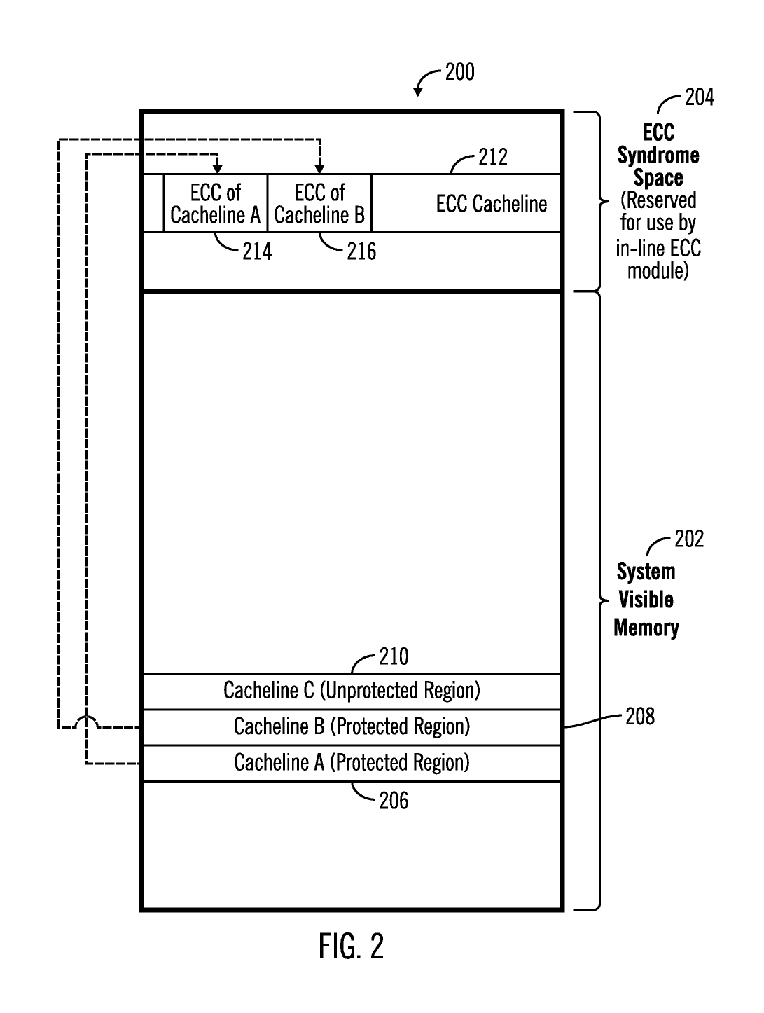

FIG. 2 illustrates a block diagram 200 that shows how the addressable memory space corresponding to the DRAM 114 is divided into a system visible memory 202 and an ECC syndrome space 204 that is an ECC data storage region, in accordance with certain embodiments. FIG. 2 also shows how the addressable memory space is divided into protected and non-protected regions in the system visible memory. For example, cacheline A 206 and cacheline B 208 are protected regions whose data needs ECC protection and the corresponding ECC data is stored in the ECC cacheline 212 in regions 214, 216 respectively. Cacheline C 210 is an unprotected region whose data does not need ECC protection.

The region for the ECC syndrome space 204 and the region for the system visible memory 202 may be programmed at boot time or may be changed dynamically at runtime. A region of memory that is reserved at boot time for ECC data storage is referred to as the ECC syndrome space 204. The size of this region depends on the protection granularity and may in certain embodiments be either 1/32, 1/16 or ⅛ of the sum of size of all protected regions. This reserved space 204 is not visible to the rest of the system and may only be used by the in-line ECC module 102.

The in-line ECC module 102 converts a read/write transaction (cache line access) to a protected region of memory into two separate memory requests. One memory request is to the actual data cache line and another to the cache line containing the ECC value. Based on the incoming read/write address, the in-line ECC module 102 determines the address of the ECC data corresponding to that cache line by using a simple address calculation.

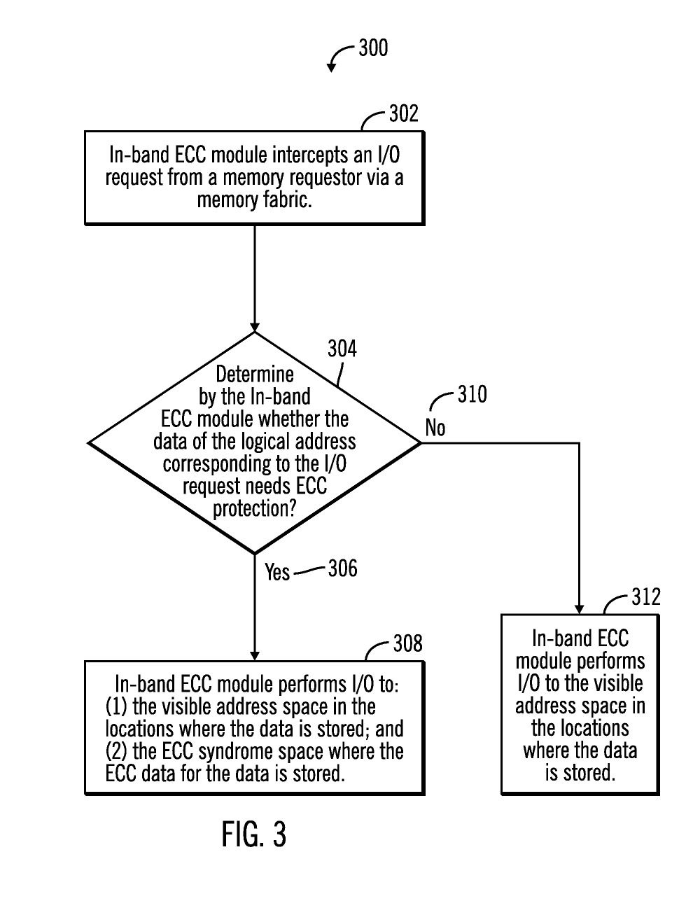

FIG. 3 illustrates a flowchart 300 that shows certain operations performed by the in-band ECC module 102, in accordance with certain embodiments.

Control starts at block 302 in which the in-band ECC module 102 intercepts an I/O request sent to the memory device 110 from a memory requestor 104, 106 via the memory fabric 108. The in-band ECC module 102 determines (at block 304) whether the data of logical address corresponding the I/O request needs ECC protection. If so (“Yes” branch 306) control proceeds to block 308 in which the in-band ECC module 102 performs I/O to the both the visible address space (i.e., the system visible memory 202) in the locations where the data is stored and to the ECC syndrome space 204 where the ECC data for the data is stored.

If at block 304 the in-band ECC module 102 determines that the data of logical address corresponding to the I/O request does not need ECC protection (“No” branch 310), then control proceeds to block 312 in which the in-band ECC module 102 performs I/O to the visible address space (i.e., the system visible memory 202) in the locations where the data is stored. There is no need to perform I/O to the ECC syndrome space as there is no ECC data for the data.

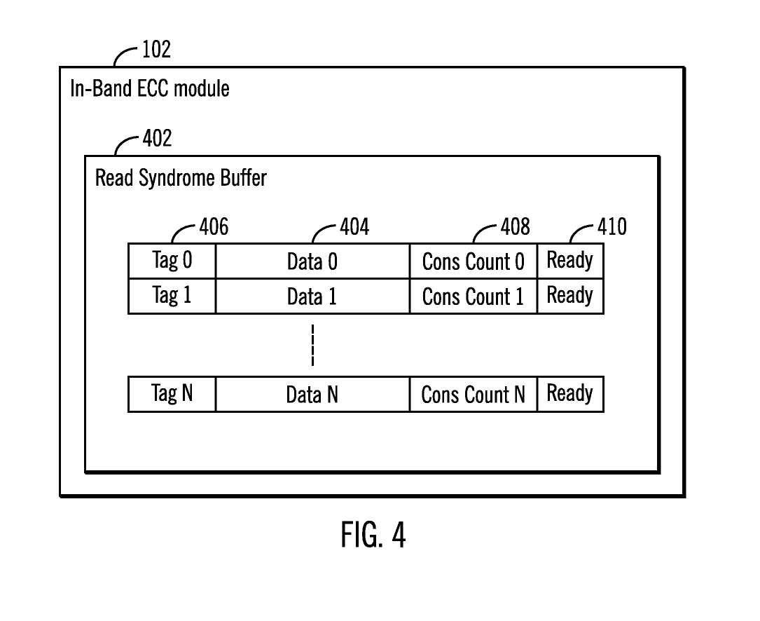

FIG. 4 illustrates a block diagram that shows an in-band ECC module 102 with a recent syndrome buffer 402, in accordance with certain embodiments;

The recent syndrome buffer 402 inside the in-band ECC 102 may be used to further reduce the bandwidth overhead by storing the recently used ECC data into an internal structure in the in-band ECC module 102 and avoid the additional read request needed to read the data from memory. Since the entirety of an ECC cacheline 212 is read while reading ECC data stored in a region of the ECC cacheline 212, the ECC data for a plurality of protected regions may be stored in the syndrome buffer 404 in anticipation of future read requests being directed to adjacent regions because of locality of reference.

For example, if a read request is for data stored in cacheline A 206, then to read the ECC data 214 of cacheline A 206, the entirety of the ECC cacheline 212 is read, and the ECC data 216 of cacheline B 208 is also read. The ECC data 216 of cacheline B 208 is stored in recent syndrome buffer 402 in anticipation of future read requests being directed to data stored in cacheline B 208.

Since a single ECC cacheline contains ECC data for 32, 16 or 8 other data lines (based on ECC protection granularity) and given that most benchmarks exhibit temporal/spatial locality, a lot of times the same ECC cache line may be re-fetched from DRAM which would significantly increase the overall DRAM bandwidth.

The read syndrome buffer 402 is a fully associative structure that contains four main fields. The DATA field 404 which holds a 64 Byte Cache Line, the tag field 406, the Consumer Count field 408 which indicates how many consumers are waiting for this DATA field from the requestor, and finally the Ready field 410 per which indicates whether the data is present in the read syndrome buffer 402 or is in transit from memory.

The in-line ECC module DATA segment may have one read and one write port. The read port may be utilized by the consumer to read data out of the DATA region and the write port may be used to store returning data into the read syndrome buffer 402. The tag look up may have just one port for address match and it may have one of the following responses: HIT indication along with the entry location and the Ready bit or MISS indication with allocation and corresponding entry location in the read syndrome buffer 402. The consumer count field 408 is decremented whenever a DATA port read occurs to the corresponding entry and it is incremented whenever a HIT occurs to that entry.

The Ready field 410 indicates whether the data is available in the read syndrome buffer 402 or whether the data is in the process of being fetched from DRAM. For every ECC protected read, once the address of ECC meta-data read is generated, it looks up the read syndrome buffer tags 406 to find if the cache line it is trying to access already exists in the read syndrome buffer 402.

In certain embodiments, writes are not to be cached in the read syndrome buffer 402. The writes invalidate a line in read syndrome buffer 402 if they hit on it. However, the read syndrome buffer 402 may also be implemented as a cache that is accessed by both reads and writes.

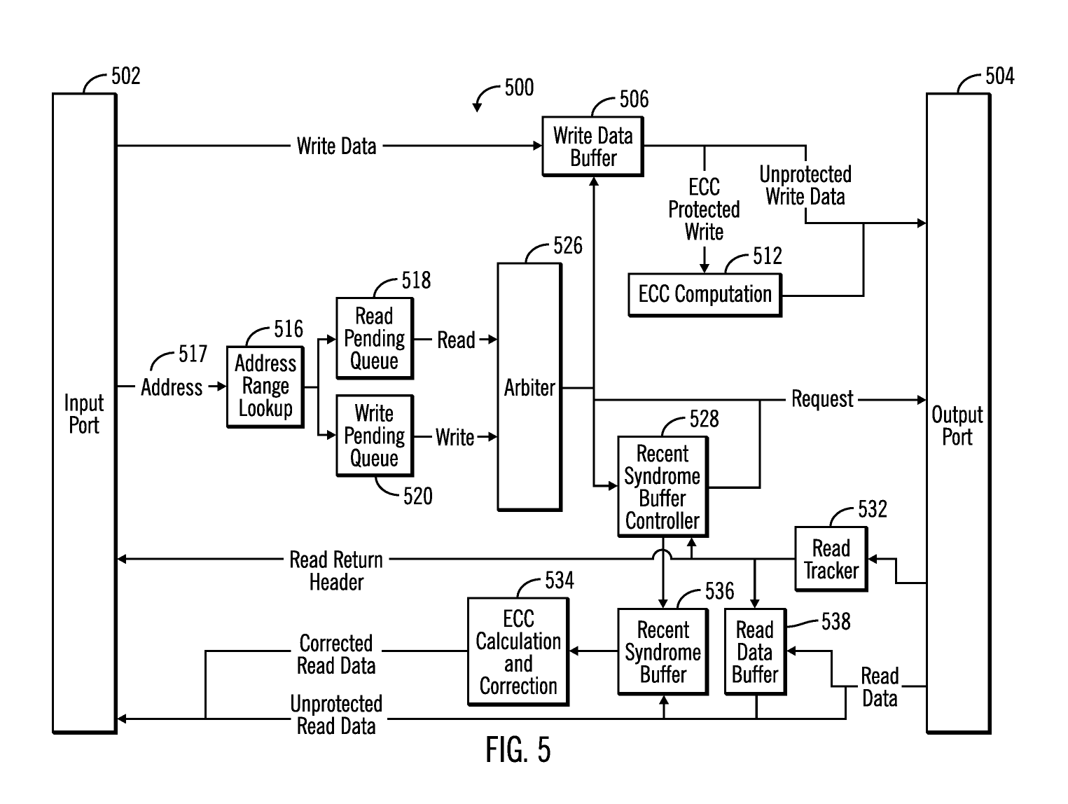

FIG. 5 illustrates a block diagram 500 that shows elements in the in-band ECC module 102 and operations performed within the in-band ECC module 102, in accordance with certain embodiments. The in-band ECC module 102 behaves as both a memory requestor and responder on the path to the addressable memory.

The in-band ECC module 102 is comprised of an input port 502, and output port 504, a write data buffer 506, an ECC computation unit 512, an address range lookup 516, a read pending queue 518, a write pending queue 520, an arbiter 526, a recent syndrome buffer controller 528, a read tracker 532, a read data buffer 538, a recent syndrome buffer 536 (corresponding to recent syndrome buffer 402) and an ECC calculation and correction unit 534.

All reads and writes entering the in-band ECC module 102 via the input port 502 go through an ECC address lookup 516 that first determines whether the given transaction is an ECC protected access, based on its address 517. Hazard checks are performed and a determination is made of the queue to send the read or write to.

The in-band ECC module 102 maintains two separate queues 518, 520 for reads and writes. The queues are combined across ECC and non-ECC traffic. Each queue entry in all the queues holds information for the data request; the ECC transaction is generated after the request wins the arbitration. The queues also maintain additional metadata to indicate whether the request is an ECC-protected transaction, whether it is currently blocked due to a dependency on another transaction, and other metadata fields to enable scheduling.

Each of the queues presents the oldest, non-blocked transaction to the main in-band ECC module arbiter 526. The in-band ECC module 102 arbiter 526 then selects one request at a time based on an arbitration policy.

For each inflight ECC-protected read transaction, the in-band ECC module 102 tracks completion of two independent reads: the data read and the ECC read. The ECC detection and correction operations 534, 544 can be performed only after the data for both read transactions are returned. Moreover, the in-band ECC module 102 assigns a new request tag to each protected read or write request. The ECC read tracker 532 holds the original read request's tag and tracks the completion of the two associated read requests.

The read data buffer 538 consists of separate storage for ECC protected read transactions and unprotected return data.

The recent syndrome buffer 536 stores the most recent accessed ECC data. Each entry in recent syndrome buffer 525 holds the ECC data for 32, 16 or 8 cachelines based on configured protection granularity.

Once the request enters the in-band ECC module 102, the address of that transaction is compared against the protected address ranges to determine whether that request is to an ECC-protected or non-protected region. The request is then allocated into one of the pending request queues.

Each of the queues presents the oldest, non-blocked transaction to the main in-band ECC module 102 scheduler. The in-band ECC module 102 then employs an arbiter 526 that schedules at a “transaction” level. For ECC-protected traffic, a transaction is consists of two reads/writes; for unprotected traffic it is just a single read/write. The ECC transaction is generated after the requests are selected by the arbiter.

The ECC data request address is computed as a function of the incoming address pointing to the ECC data storage region.

Once a winner transaction is selected, the in-band ECC module 102 scheduler ensures that it is atomically issued. This essentially means that if an ECC-protected transaction is selected, then both of the reads/writes to data and the ECC are issued back-to-back, and no other intervening read/write from another transaction can be issued.

Read data buffer (RDB) 538 is the temporary storage for all in-flight protected data and their ECC values. Before sending the request the in-band ECC module 102 may ensure that there are pre-assigned data return slots in the read data return buffer for returning the data and its ECC data. For unprotected traffic, there are dedicated first in first out (FIFO) data structures.

The ECC read data tracker 532 structure operates in lockstep with the recent syndrome buffer 536 and keeps the header information for the original request, as well as tracking details of when the data is returned and ready to be consumed.

Every request entering the in-band ECC module 102 goes through an ECC address lookup to determine whether it is a protected transaction. There can be many types of requests, based on whether it is protected/unprotected and read/full write/partial write.

An unprotected read entering the in-band ECC module 102 is directed to the Read Pending Queue 518, which supports scheduling based on the age. The read address is checked against the Write Pending Queue 520 to see if there are any dependencies with writes waiting in the queue. If there is a match, the newer write is blocked in the queue until all previous writes to the same address are scheduled. When the read's data returns from the memory controller, the in-band ECC module 102 checks the tag information to determine whether the data is for protected traffic or unprotected traffic. In the case of unprotected read, the read data bypasses the ECC check engine and is sent to the original requestor.

An unprotected full write transaction entering the in-band ECC module 102 is directed to the Write Pending Queue 520 that supports scheduling based on age. The write checks the address against other entries in the queue to see if it has any dependencies with older writes and reads to the same address and gets blocked until the dependency is resolved. For an unprotected write and partial write, in-band ECC module 102 just behaves as a forwarding agent with no ECC generation needed.

Similar to unprotected read, on allocation, the protected read transaction looks up the Write Pending Queue 520 to find all of the transactions (data/ECC pairs) it is blocked on. The protected reads remain blocked until they see both the data and the ECC request to that address go out from the scheduler. Once the read request wins the arbitration, it checks the recent syndrome buffer 536 to see whether the ECC data for that request already exists. On a miss, a new entry is allocated in the recent syndrome buffer 536 when the buffer is not full, or if the recent syndrome buffer is full, one of the entries in the recent syndrome buffer 536 with no waiting consumers will be deallocated and the new entry will be allocated in that location. The entry number is stored in the Read Tracker 532. At the same time ECC data transaction is generated in parallel and is sent immediately after the read data request. On a hit, the recent syndrome buffer controller 528 increments the consumer counter of the entry and also returns the entry number in the recent syndrome buffer 536 where it is stored. This entry number will be stored in the ECC Read Tracker 532 and will be utilized when the corresponding data is present in the recent syndrome buffer 536. In this case the ECC data transaction is not generated since the recent syndrome buffer will have the data ready. On the return path, in-band ECC module 102 waits for both the data access and ECC access (if not present in the recent syndrome buffer) to return before performing the ECC detection/correction operations. The readiness of the needed ECC data will be tracked by the read tracker. The in-band ECC module 102 needs to ensure that there are slots in the Read data buffer/Read tracker structure where the returning transactions can be held before it can be issued to ECC logic. To solve this issue, the in-band ECC module 102 pre-allocates the entry in the tracker at the point of scheduling. When a protected read data returns, the in-band ECC module 102 can identify at which location in the read data buffer 538 it should be written. When the ECC data returns to the in-band ECC module 102 recent syndrome buffer 536, the entry number will be broadcast to all the waiting consumers in the read tracker and it will check whether it is equal to the entry it is waiting for and therefore be able to track when the ECC data has arrived and is ready for consumption from the recent syndrome buffer 536. Once both accesses are in read data buffer 538 and recent syndrome buffer 536, the in-band ECC module 102 schedules the request to the ECC calculation and correction logic 534. The corrected data is then placed in the appropriate First In First Out (FIFO) queue and sent to the requestor.

When a protected write transaction enters the in-band ECC module 102, the request information is allocated in the Write Pending Queue, and the data is stored in Write Data Buffer. The ECC request address, value, and byte enables for a protected write are not stored but are generated on the fly, when the transaction is scheduled. In-band ECC module 102 needs to ensure Write after Write and Write after Read ordering as well as invalidation of the corresponding ECC data in recent syndrome buffer 536 if present. To ensure this, an incoming write request checks against all of the reads in the pending queues, all of the outstanding reads waiting in the tracker/read data buffer, all of the writes in the Write Pending Queue and valid entries in recent syndrome buffer.

A protected partial write transaction in the in-band ECC module 102 is essentially composed of two protected transactions: A protected underfill read transaction and a protected full write transaction. The hazard management is the same as the full write case. Note, however, that the underfill read transaction cannot be issued without all of the hazards and dependencies clearing. The in-band ECC module 102 scheduler needs to be aware that it is issuing an underfill read, and the tracker/read data buffer structures need to set the underfill field, as well as indicate which entry in the write queue is the recipient of the underfill read. Once the underfill read is complete, the corrected data is directed back to the Write Data Buffer, where it is merged with the partial data. After this point, the Write Pending Queue will now present a protected full write to the in-band ECC module 102 scheduler.

The error detection and correction is done by adding 16 bits on every 512, 256 or 128 data bits that are written to memory (based on protection granularity configuration). The creation of the each ECC bit is done by XOR-ing a certain combination of the written bits according to a hamming matrix. When reading the data, 16-bit syndrome are created by XOR-ing each ECC bit with the same bits that originally created them.

The syndrome analysis shows the error, if it is correctable, and how to correct it.

The in-band ECC module 102 needs to identify ECC errors and report them. The in-band ECC module 102 may generate an error message to a collector module whenever an ECC error occurs. The error message indicates whether the error is correctable or uncorrectable error and system software may then investigate the corresponding Error Log Registers to find out more details about the error.

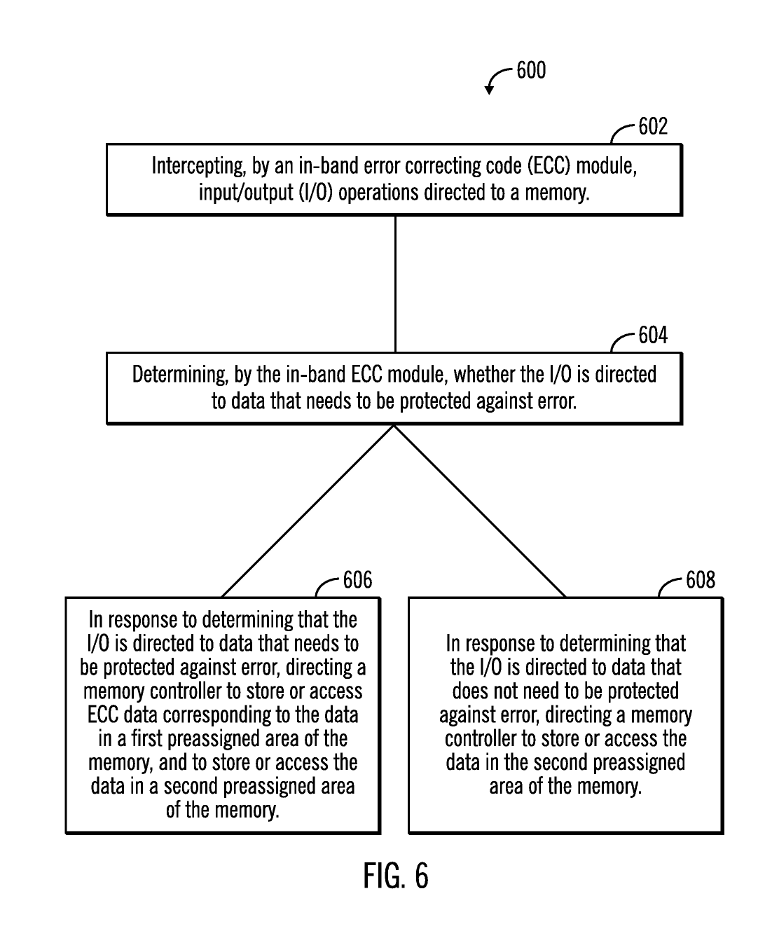

FIG. 6 illustrates a flowchart 600 that shows certain additional operations performed by the in-band ECC module 102, in accordance with certain embodiments.

Control starts at block 602 in which an in-band error correcting code (ECC) module 102 intercepts input/output (I/O) operations directed to a memory (e.g., DRAM 114). The in-band ECC module 102 determines (at block 604) whether the I/O is directed to data that needs to be protected against error.

If the in-band ECC module 102 determines that the I/O is directed to data that needs to be protected against error, then from block 604 control proceeds to block 606 in which the in-band ECC module 102 directs a memory controller to store or access ECC data corresponding to the data in a first preassigned area 204 of the memory, and to store or access the data in a second preassigned area 202 of the memory.

If the in-band ECC module 102 determines that the I/O is directed to data that does not need to be protected against error, then from block 604 control proceeds to block 608 in which the in-band ECC module 102 directs a memory controller to store or access the data in a second preassigned area 202 of the memory.

In certain embodiments, the in-band ECC module 102 stores in a read syndrome buffer all ECC data that are in an ECC cacheline. The in-band ECC module 102 uses the ECC data stored in the read syndrome buffer to perform error detection and correction of data that is read from the memory, if the ECC data to determine correctness of the data that is read from memory is already stored in the read syndrome buffer.

The embodiments described above may provide improvements to memory technology. For example, in order to use out of band ECC with LPDDR technology, one additional device needs to be added to each memory channel. This is really cost prohibitive as the total number of devices can be doubled because of ECC, and moreover the board may not have the real state space to attach the additional devices. In-band ECC without address range only allows all of memory to be protected or all of memory to not be protected. The bandwidth overhead and storage overhead associated with in-band ECC with this approach may result in significant performance degradation for all workloads. In-band ECC without recent syndrome buffer has significant bandwidth overhead as every request spawns an additional ECC data read/write. Recent syndrome buffer tries to reduce this bandwidth overhead by storing most recent ECC data in the module. The in-band ECC module as a standalone module allows for portability of the module to sit before any memory storage element and provide ECC capability. It can also allow for reuse of the module across many projects.

The described operations may be implemented as a method, apparatus or computer program product using standard programming and/or engineering techniques to produce software, firmware, hardware, or any combination thereof. The described operations may be implemented as code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals. Those skilled in the art will recognize that many modifications may be made to this configuration, and that the article of manufacture may comprise suitable information bearing medium known in the art.

Computer program code for carrying out operations for aspects of the certain embodiments may be written in any combination of one or more programming languages. Blocks of the flowchart and block diagrams may be implemented by computer program instructions.

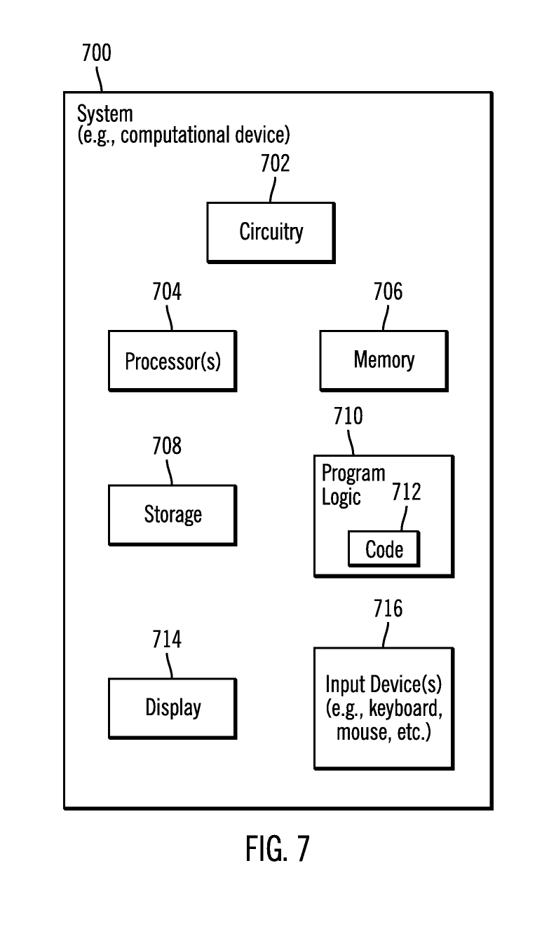

FIG. 7 illustrates a block diagram of a system 700 that includes a computational device that includes the in-band ECC module 102, in accordance with certain embodiments. For example, in certain embodiments the system 700 may be a computer (e.g., a laptop computer, a desktop computer, a tablet, a cell phone or any other suitable computational device) that has the host 102 and the solid state drive 104 both included in the system 700. For example, in certain embodiments the system 700 may be a laptop computer that includes the solid state drive 104. The system 700 may include a circuitry 702 that may in certain embodiments include at least a processor 704. The system 700 may also include a memory 706 (e.g., a volatile memory device), and storage 708. The storage 708 may include the DRAM 114 or other drives or devices including a non-volatile memory device (e.g., EEPROM, ROM, PROM, flash, firmware, programmable logic, etc.). The storage 708 may also include a magnetic disk drive, an optical disk drive, a tape drive, etc. The storage 708 may comprise an internal storage device, an attached storage device and/or a network accessible storage device. The system 700 may include a program logic 710 including code 712 that may be loaded into the memory 706 and executed by the processor 704 or circuitry 702. In certain embodiments, the program logic 710 including code 712 may be stored in the storage 708. In certain other embodiments, the program logic 710 may be implemented in the circuitry 702. Therefore, while FIG. 7 shows the program logic 710 separately from the other elements, the program logic 710 may be implemented in the memory 706 and/or the circuitry 702. The system 700 may also include a display 714 (e.g., an liquid crystal display (LCD), a light emitting diode (LED) display, a cathode ray tube (CRT) display, a touchscreen display, or any other suitable display). The system 700 may also include one or more input devices 716, such as, a keyboard, a mouse, a joystick, a trackpad, or any other suitable input devices). Other components or devices beyond those shown in FIG. 7 may also be found in the system 700.

Certain embodiments may be directed to a method for deploying computing instruction by a person or automated processing integrating computer-readable code into a computing system, wherein the code in combination with the computing system is enabled to perform the operations of the described embodiments.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

### EXAMPLES

The following examples pertain to further embodiments.

Example 1 is a method for error correction, comprising: intercepting, by an in-band error correcting code (ECC) module, input/output (I/O) operations directed to a memory; determining, by the in-band ECC module, whether the I/O is directed to data that needs to be protected against error; and in response to determining that the I/O is directed to data that needs to be protected against error, directing a memory controller to store or access ECC data corresponding to the data in a first preassigned area of the memory, and to store or access the data in a second preassigned area of the memory.

In example 2, the subject matter of example 1 may include operations comprising: in response to determining that the I/O is directed to data that does not need to be protected against error, directing the memory controller to store or access the data in the second preassigned area of the memory.

In example 3, the subject matter of example 1 may include operations comprising: storing in a read syndrome buffer of the in-band ECC module all ECC data that are in a ECC cacheline; and using ECC data stored in the read syndrome buffer to perform error detection and correction of data that is read from the memory, if the ECC data to determine correctness of the data that is read from memory is already stored in the read syndrome buffer.

In example 4, the subject matter of example 1 may include that the in-band ECC module is a standalone module that is placed between a memory requestor and a memory controller for the memory.

In example 5, the subject matter of example 1 may include that the first preassigned area is exclusively reserved for storing ECC data.

In example 6, the subject matter of example 1 may include that the second preassigned area has a first dedicated region for storing data that is to be protected via ECC and a second dedicated region for storing data that is not be protected via ECC.

Example 7 is an in-band error correcting code (ECC) module that is communicatively coupled to a memory controller, wherein the in-band ECC module is configured to perform: intercept input/output (I/O) operations directed to a memory; determine whether the I/O is directed to data that needs to be protected against error; and in response to a determination that the I/O is directed to data that needs to be protected against error, direct the memory controller to store or access ECC data corresponding to the data in a first preassigned area of the memory, and to store or access the data in a second preassigned area of the memory.

In example 8, the subject matter of example 7 may include that the in-band ECC module is configured to perform: in response to a determination that the I/O is directed to data that does not need to be protected against error, direct the memory controller to store or access the data in the second preassigned area of the memory.

In example 9, the subject matter of example 7 may include that the in-band ECC module is configured to perform: store in a read syndrome buffer of the in-band ECC module all ECC data that are in a ECC cacheline; and use ECC data stored in the read syndrome buffer to perform error detection and correction of data that is read from the memory, if the ECC data to determine correctness of the data that is read from memory is already stored in the read syndrome buffer.

In example 10, the subject matter of example 7 may include that the in-band ECC module is a standalone module that is placed between a memory requestor and a memory controller for the memory.

In example 11, the subject matter of example 7 may include that the first preassigned area is exclusively reserved for storing ECC data.

In example 12, the subject matter of example 7 may include that the second preassigned area has a first dedicated region for storing data that is to be protected via ECC and a second dedicated region for storing data that is not be protected via ECC.

Example 13 is a memory controller for error correction, including an in-band error correcting code (ECC) module, wherein the in-band ECC module is configured to perform: intercept input/output (I/O) operations directed to a memory; determine whether the I/O is directed to data that needs to be protected against error; and in response to a determination that the I/O is directed to data that needs to be protected against error, direct the memory controller to store or access ECC data corresponding to the data in a first preassigned area of the memory, and to store or access the data in a second preassigned area of the memory.

In example 14, the subject matter of example 13 may include that the in-band ECC module is configured to perform: in response to a determination that the I/O is directed to data that does not need to be protected against error, direct the memory controller to store or access the data in the second preassigned area of the memory.

In example 15, the subject matter of example 13 may include that the in-band ECC module is configured to perform: store in a read syndrome buffer of the in-band ECC module all ECC data that are in a ECC cacheline; and use ECC data stored in the read syndrome buffer to perform error detection and correction of data that is read from the memory, if the ECC data to determine correctness of the data that is read from memory is already stored in the read syndrome buffer.

In example 16, the subject matter of example 13 may include that the in-band ECC module is a standalone module that is placed between a memory requestor and a memory controller for the memory.

In example 17, the subject matter of example 13 may include that the first preassigned area is exclusively reserved for storing ECC data.

In example 18, the subject matter of example 13 may include that the second preassigned area has a first dedicated region for storing data that is to be protected via ECC and a second dedicated region for storing data that is not be protected via ECC.

Example 19 is a system for error correction, comprising: a memory; a memory controller coupled to the memory; an in-band error correcting code (ECC) module coupled to the memory controller; and a display communicatively coupled to the memory to display data stored in the memory, wherein the in-band ECC module is operable to: intercept input/output (I/O) operations directed to the memory; determine whether the I/O is directed to data that needs to be protected against error; and in response to a determination that the I/O is directed to data that needs to be protected against error, direct the memory controller to store or access ECC data corresponding to the data in a first preassigned area of the memory, and to store or access the data in a second preassigned area of the memory.

In example 20 the subject matter of example 19 may include that the in-band ECC module is further operable to: in response to a determination that the I/O is directed to data that does not need to be protected against error, direct the memory controller to store or access the data in the second preassigned area of the memory.

In example 21 the subject matter of example 19 may include that the in-band ECC module is further operable to: store in a read syndrome buffer of the in-band ECC module all ECC data that are in a ECC cacheline; and use ECC data stored in the read syndrome buffer to perform error detection and correction of data that is read from the memory, if the ECC data to determine correctness of the data that is read from memory is already stored in the read syndrome buffer.

In example 22, the subject matter of example 19 may include that the in-band ECC module is a standalone module that is placed between a memory requestor and a memory controller for the memory.

In example 23, the subject matter of example 19 may include that the first preassigned area is exclusively reserved for storing ECC data.

In example 24, the subject matter of example 19 may include that the second preassigned area has a first dedicated region for storing data that is to be protected via ECC and a second dedicated region for storing data that is not be protected via ECC.

Example 25 is a memory device for error correction, comprising: a memory; a memory controller coupled to the memory; an in-band error correcting code (ECC) module coupled to the memory controller, wherein the in-band ECC module is operable to: intercept input/output (I/O) operations directed to a memory; determine whether the I/O is directed to data that needs to be protected against error; an in response to a determination that the I/O is directed to data that needs to be protected against error, direct the memory controller to store or access ECC data corresponding to the data in a first preassigned area of the memory, and to store or access the data in a second preassigned area of the memory.

In example 26, the subject matter of example 25 may include that the in-band ECC module is further operable to: store in a read syndrome buffer of the in-band ECC module all ECC data that are in a ECC cacheline; and use ECC data stored in the read syndrome buffer to perform error detection and correction of data that is read from the memory, if the ECC data to determine correctness of the data that is read from memory is already stored in the read syndrome buffer.

In example 27, the subject matter of example 25 may include that the in-band ECC module is configured to perform: store in a read syndrome buffer of the in-band ECC module all ECC data that are in a ECC cacheline; and use ECC data stored in the read syndrome buffer to perform error detection and correction of data that is read from the memory, if the ECC data to determine correctness of the data that is read from memory is already stored in the read syndrome buffer.

In example 28, the subject matter of example 25 may include that the in-band ECC module is a standalone module that is placed between a memory requestor and a memory controller for the memory.

In example 29, the subject matter of example 25 may include that the first preassigned area is exclusively reserved for storing ECC data.

In example 30, the subject matter of example 25 may include that the second preassigned area has a first dedicated region for storing data that is to be protected via ECC and a second dedicated region for storing data that is not be protected via ECC.

Example 31 is a system for error correction, the system comprising: means for intercepting, by an in-band error correcting code (ECC) module, input/output (I/O) operations directed to a memory; means for determining, by the in-band ECC module, whether the I/O is directed to data that needs to be protected against error; and means for performing in response to determining that the I/O is directed to data that needs to be protected against error, directing a memory controller to store or access ECC data corresponding to the data in a first preassigned area of the memory, and to store or access the data in a second preassigned area of the memory.

All optional features of any of the systems and/or apparatus described above may also be implemented with respect to the method or process described above, and specifics in the examples may be used anywhere in one or more embodiments. Additionally, all optional features of the method or process described above may also be implemented with respect to any of the system and/or apparatus described above, and specifics in the examples may be used anywhere in one or more embodiments.

What is claimed is:

1. A method, comprising:
intercepting, by an in-band error correcting code (ECC) module, input/output (I/O) operations directed to a memory;
determining, by the in-band ECC module, whether the I/O is directed to data that needs to be protected against error; and
in response to determining that the I/O is directed to data that needs to be protected against error, directing a memory controller to store or access ECC data corresponding to the data in a first preassigned area of the memory, and to store or access the data in a second preassigned area of the memory.

2. The method of claim 1, the method further comprising:
in response to determining that the I/O is directed to data that does not need to be protected against error, directing the memory controller to store or access the data in the second preassigned area of the memory.

3. The method of claim 1, the method further comprising:
storing in a read syndrome buffer of the in-band ECC module all ECC data that are in a ECC cacheline; and
using ECC data stored in the read syndrome buffer to perform error detection and correction of data that is read from the memory, if the ECC data to determine correctness of the data that is read from memory is already stored in the read syndrome buffer.

4. The method of claim 1, wherein the in-band ECC module is a standalone module that is placed between a memory requestor and a memory controller for the memory.

5. The method of claim 1, wherein the first preassigned area is exclusively reserved for storing ECC data.

6. The method of claim 1, wherein the second preassigned area has a first dedicated region for storing data that is to be protected via ECC and a second dedicated region for storing data that is not be protected via ECC.

7. An in-band error correcting code (ECC) module that is communicatively coupled to a memory controller, wherein the in-band ECC module is configured to perform:
intercept input/output (I/O) operations directed to a memory;
determine whether the I/O is directed to data that needs to be protected against error; and
in response to a determination that the I/O is directed to data that needs to be protected against error, direct the memory controller to store or access ECC data corresponding to the data in a first preassigned area of the memory, and to store or access the data in a second preassigned area of the memory.

8. The in-band ECC module of claim 7, wherein the in-band ECC module is configured to perform:
in response to a determination that the I/O is directed to data that does not need to be protected against error, direct the memory controller to store or access the data in the second preassigned area of the memory.

9. The in-band ECC module of claim 7, wherein the in-band ECC module is further configured to perform:
store in a read syndrome buffer of the in-band ECC module all ECC data that are in a ECC cacheline; and
use ECC data stored in the read syndrome buffer to perform error detection and correction of data that is read from the memory, if the ECC data to determine correctness of the data that is read from memory is already stored in the read syndrome buffer.

10. The in-band ECC module of claim 7, wherein the in-band ECC module is a standalone module that is placed between a memory requestor and the memory controller for the memory.

11. The in-band ECC module of claim 7, wherein the first preassigned area is exclusively reserved for storing ECC data.

12. The in-band ECC module of claim 7, wherein the second preassigned area has a first dedicated region for storing data that is to be protected via ECC and a second dedicated region for storing data that is not be protected via ECC.

13. A memory controller including an in-band error correcting code (ECC) module, wherein the in-band ECC module is configured to perform:
intercept input/output (I/O) operations directed to a memory;
determine whether the I/O is directed to data that needs to be protected against error; and
in response to a determination that the I/O is directed to data that needs to be protected against error, direct the memory controller to store or access ECC data corresponding to the data in a first preassigned area of the memory, and to store or access the data in a second preassigned area of the memory.

14. The memory controller of claim 13, wherein the in-band ECC module is further configured to perform:
in response to a determination that the I/O is directed to data that does not need to be protected against error, direct the memory controller to store or access the data in the second preassigned area of the memory.

15. The memory controller of claim 13, wherein the in-band ECC module is further configured to perform:
store in a read syndrome buffer of the in-band ECC module all ECC data that are in a ECC cacheline; and
use ECC data stored in the read syndrome buffer to perform error detection and correction of data that is read from the memory, if the ECC data to determine correctness of the data that is read from memory is already stored in the read syndrome buffer.

16. A system, comprising:
a memory;
a memory controller coupled to the memory;
an in-band error correcting code (ECC) module coupled to the memory controller; and
a display communicatively coupled to the memory to display data stored in the memory, wherein the in-band ECC module is operable to:
intercept input/output (I/O) operations directed to the memory;
determine whether the I/O is directed to data that needs to be protected against error; and
in response to a determination that the I/O is directed to data that needs to be protected against error, direct the memory controller to store or access ECC data corresponding to the data in a first preassigned area of the memory, and to store or access the data in a second preassigned area of the memory.

17. The system of claim 16, wherein the in-band ECC module is further operable to:
in response to a determination that the I/O is directed to data that does not need to be protected against error, direct the memory controller to store or access the data in the second preassigned area of the memory.

18. The system of claim 16, wherein the in-band ECC module is further operable to:
store in a read syndrome buffer of the in-band ECC module all ECC data that are in a ECC cacheline; and
use ECC data stored in the read syndrome buffer to perform error detection and correction of data that is read from the memory, if the ECC data to determine correctness of the data that is read from memory is already stored in the read syndrome buffer.

19. A memory device, comprising:
a memory;
a memory controller coupled to the memory;
an in-band error correcting code (ECC) module coupled to the memory controller, wherein the in-band ECC module is operable to:
intercept input/output (I/O) operations directed to a memory;
determine whether the I/O is directed to data that needs to be protected against error; and
in response to a determination that the I/O is directed to data that needs to be protected against error, direct the memory controller to store or access ECC data corresponding to the data in a first preassigned area of the memory, and to store or access the data in a second preassigned area of the memory.

20. The memory device of claim 19, wherein the in-band ECC module is further operable to:
store in a read syndrome buffer of the in-band ECC module all ECC data that are in a ECC cacheline; and
use ECC data stored in the read syndrome buffer to perform error detection and correction of data that is read from the memory, if the ECC data to determine correctness of the data that is read from memory is already stored in the read syndrome buffer.
